(19) United States
(12) Patent Application Publication
(10) Pub. No.: US 2026/0169926 A1
(43) Pub. Date: Jun. 18, 2026

(54) DATA PRELOADING METHOD AND ELECTRONIC DEVICE FOR PERFORMING THE SAME

(71) Applicant: SAMSUNG ELECTRONICS CO., LTD., Suwon-si (KR)

(72) Inventor: Jusin KIM, Suwon-si (KR)

(73) Assignee: SAMSUNG ELECTRONICS CO., LTD., Suwon-si (KR)

(21) Appl. No.: 19/329,013

(22) Filed: Sep. 15, 2025

Related U.S. Application Data
(63) Continuation of application No. PCT/KR2025/012935, filed on Aug. 25, 2025.

(30) Foreign Application Priority Data
Nov. 6, 2024 (KR) 10-2024-0156465

(51) Int. Cl. G06F 12/109; G06F 9/30

(52) U.S. Cl. CPC G06F 12/109; G06F 9/30047; G06F 2212/654

(57) ABSTRACT

A method of preloading data is provided. The method includes, based on a data load request being identified, identifying a current process identifier (ID) and a virtual address where data is to be loaded, translating the virtual address into a physical address based on a page table, predicting a physical address of next data to be used in a process corresponding to the current process ID based on the translated physical address, when the current process ID is the same as a previous process ID, and preloading the next data into a main memory based on the predicted physical address.

### DESCRIPTION

### CROSS-REFERENCE TO RELATED APPLICATION(S)

This application is a continuation application, claiming priority under §111(a), of International Application No. PCT/KR2025/012935, filed on August 25, 2025, which is based on and claims the benefit of Korean Patent Application No.: 10-2024-0156465, filed November 6, 2024, in the Korean Intellectual Property Office, the disclosures of which are incorporated by reference herein in their entireties.

### TECHNICAL FIELD

The disclosure relates to a method of preloading data by predicting data to be loaded based on a predictive model, and an electronic device for performing the method.

### BACKGROUND ART

Data preloading is an optimization technique used to increase processing speed in various computing tasks involving data processing. Preparing necessary data in advance may reduce processing delays but also increase memory usage and potentially lead to loading of unnecessary data.

Data preloading is effectively applied to predictable processes, but use of the data preloading is limited in processes that are difficult to predict due to many variables. Accordingly, there is a need to optimize performance by efficiently predicting and preloading data for an electronic device that performs unpredictable processes in various environments.

### DISCLOSURE

### TECHNICAL SOLUTION

According to an aspect of the disclosure, an electronic device for performing a data preloading method may be provided. The electronic device may include a system on chip including at least one processor, and a storage to store instructions and a main memory into which the instructions are loaded. The instructions executable by the at least one processor in the system on chip, may cause the electronic device to identify, based on a data load request, a current process identifier (ID) and a virtual address where data is to be loaded, translate the virtual address into a physical address based on a page table stored in the storage, predict, a physical address of next data to be used in a process corresponding to the current process ID based on the translated physical address, when the current process ID is the same as a previous process ID, and preload the next data into the main memory based on the predicted physical address.

According to an aspect of the disclosure, a method, performed by an electronic device, of preloading data may be provided. The method may include, based on a data load request being identified, identifying a current process ID and a virtual address where data is to be loaded, translating the virtual address into a physical address based on a page table, predicting a physical address of next data to be used in a process corresponding to the current process ID based on the translated physical address, when the current process ID is the same as a previous process ID, and preloading the next data into a main memory based on the predicted physical address.

### DESCRIPTION OF DRAWINGS

FIG. 1 is an example for explaining data preloading by an electronic device, according to an embodiment of the disclosure.

FIG. 2 is a diagram illustrating processes executed by an electronic device, according to an embodiment of the disclosure.

FIG. 3 is a flowchart illustrating an operation in which an electronic device preloads data, according to an embodiment of the disclosure.

FIG. 4 is a block diagram of a configuration of an electronic device according to an embodiment of the disclosure.

FIG. 5 is a block diagram of a configuration of a prediction preload block (PPB) in an electronic device, according to an embodiment of the disclosure.

FIG. 6 is a diagram illustrating an operation in which an electronic device predicts a physical address and preloads data, according to an embodiment of the disclosure.

FIG. 7 is a diagram illustrating an operation in which an electronic device translates a virtual address into a physical address, according to an embodiment of the disclosure.

FIG. 8 is a diagram illustrating an operation in which an electronic device preloads data, according to an embodiment of the disclosure.

FIG. 9 is a diagram illustrating an operation in which an electronic device trains a predictive model for predicting a physical address, according to an embodiment of the disclosure.

FIG. 10 is a diagram illustrating an operation in which an electronic device generates training data for a predictive model, according to an embodiment of the disclosure.

FIG. 11 is a diagram illustrating a predictive model used by an electronic device to predict a physical address, according to an embodiment of the disclosure.

FIG. 12 is a diagram illustrating an operation in which an electronic device collects a usage pattern of the electronic device, according to an embodiment of the disclosure.

FIG. 13 is a block diagram of a configuration of an electronic device according to an embodiment of the disclosure.

FIG. 14 is a block diagram of a configuration of an electronic device according to an embodiment of the disclosure.

### MODE FOR INVENTION

Terms used in the present specification will now be briefly described and then the disclosure will be described in detail. Throughout the disclosure, the expression "at least one of a, b or c" indicates only a, only b, only c, both a and b, both a and c, both b and c, all of a, b, and c, or variations thereof.

The terms used in the disclosure may be general terms currently widely used in the art by taking into account functions described herein, but may vary according to an intention of skilled persons in the related art, precedent cases, advent of new technologies, etc. Furthermore, specific terms may be arbitrarily selected by the applicant, and in this case, the meaning of the selected terms will be described in detail in the relevant description. Thus, the terms used herein should be defined not by simple appellations thereof but based on the meaning of the terms together with the overall description of the disclosure.

Singular expressions used herein are intended to include plural expressions as well unless the context clearly indicates otherwise. All the terms used herein, which include technical or scientific terms, may have the same meaning that is generally understood by one of ordinary skill in the art. Furthermore, although the terms including an ordinal number such as "first", "second", etc. may be used herein to describe various elements or components, these elements or components should not be limited by the terms. The terms are only used to distinguish one element or component from another element or component.

Throughout the specification, when a part "includes" or "comprises" an element, unless there is a particular description contrary thereto, it is understood that the part may further include other elements, not excluding the other elements. In addition, terms such as "unit", "module", etc., described herein refer to a unit for processing at least one function or operation and may be implemented as hardware or software, or a combination of hardware and software.

An embodiment of the disclosure will be described more fully hereinafter with reference to the accompanying drawings so that the embodiment thereof may be easily implemented by one of ordinary skill in the art. However, the disclosure may be implemented in many different forms and should not be construed as being limited to an embodiment of the disclosure set forth herein. Furthermore, parts not related to the descriptions are omitted to clearly illustrate the disclosure in the drawings. In addition, for convenience of descriptions, different reference numerals are used throughout the specification even for identical elements or components.

Hereinafter, the disclosure is described in detail with reference to the accompanying drawings.

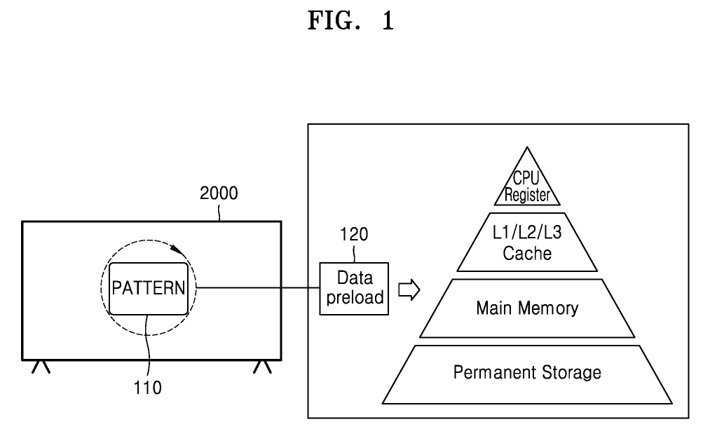

FIG. 1 is an example for explaining data preloading by an electronic device, according to an embodiment of the disclosure.

In an embodiment of the disclosure, the electronic device 2000 may predict data to be used next based on a pattern 110 and perform data preloading 120. The electronic device 2000 may predict a physical address of the data to be used next via analysis of the pattern 110, and optimize the performance of the electronic device 2000 through the data preloading 120 from the predicted address.

A general computer architecture is organized as a data hierarchy structure consisting of central processing unit (CPU) registers, caches (Level 1 (L1), Level 2 (L2), and Level 3 (L3)), main memory (dynamic random access memory (DRAM)), and permanent storage (hard disk drive (HDD) and solid state drive (SSD)). In this hierarchy structure, frequently used data is located in layers closer to a CPU (registers and caches), while less frequently used data is stored in layers farther away from the CPU (main memory and permanent storage). Through the hierarchy structure, the electronic device 2000 optimizes performance by leveraging spatial locality and temporal locality. Spatial locality refers to the tendency to use adjacent data together when accessing data, while temporal locality refers to the tendency to access recently used data again. By applying the spatial and temporal locality, the CPU may quickly access required data, improving the overall processing performance of the system. However, when the spatial and temporal locality is not satisfied, data misses may occur, resulting in additional time required to load data from lower-level memory to higher-level memory.

Operations of the electronic device 2000 involve numerous processes. In general, the data preloading 120 is already performed for predictable processes. This refers to cases where data to be loaded is predictable and therefore data stored in a permanent storage may be loaded into a main memory, such as processes that need to be executed (e.g., essential processes executed during bootup).

However, in cases where variable factors such as user intervention or changes in the surrounding environment affect the operation of the electronic device 2000, processes executed by the electronic device 2000 may be classified as unpredictable processes.

In the case of the electronic device 2000 (e.g., a television (TV), etc.) used by a user, there may be the pattern 110 that is a repetition in the user's use of the electronic device 2000, and by preloading data that is to be loaded into the electronic device 2000 in the near future from permanent storage into main memory by using the repetition pattern 110, the performance of the electronic device 2000 may be improved. The pattern 110 includes a usage pattern of the electronic device 2000 and may also include a memory access pattern for processes included in the usage pattern.

For example, the electronic device 2000 may be implemented as various types and forms of electronic devices including displays. For example, the electronic device 2000 may include a smart TV, a smartphone, a tablet personal computer (PC), a laptop PC, a picture frame display, etc., but is not limited thereto. In an embodiment of the disclosure, the electronic device 2000 may be an electronic device such as a set-top box or a desktop PC that does not include a display and is connected to a separate display device to provide media content.

Specific operations in which the electronic device 2000 performs the data preloading 120 based on predictions using the pattern 110 are described in more detail with reference to the drawings and descriptions thereof as described below.

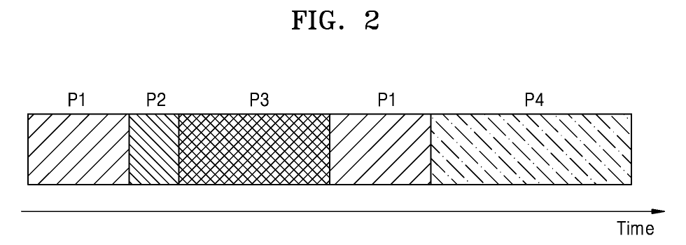

FIG. 2 is a diagram illustrating processes executed by an electronic device, according to an embodiment of the disclosure.

In an embodiment of the disclosure, the electronic device 2000 supports multitasking capable of processing multiple tasks simultaneously. For example, while the user is running an application (or app) or using a system function on the electronic device 2000, various tasks are processed simultaneously, and a scheduler manages multiple processes.

For example, the electronic device 2000 may execute multiple processes in an interleaved manner according to scheduling. As shown in FIG. 2, a first process P1, a second process P2, a third process P3, and a fourth process P4 may be processed in an interleaved manner according to scheduling. In detail, when a user runs an application to stream video, various processes related to the video streaming, such as decoding, outputting on a screen, and playing audio, are executed. In addition, when the user of the electronic device 2000 performs a search via a web browser while streaming video, a web page rendering process may also be scheduled.

In other words, in a multitasking environment where the electronic device 2000 is used, it is difficult to predict what the next process will be because each user has a different usage pattern for the electronic device 2000, even the same user may have an irregular usage pattern, etc. Furthermore, because processes that run when the electronic device 2000 boots up are different depending on an installation environment of the electronic device 2000 (e.g., whether the electronic device 2000 is connected to a network, etc.), it is also difficult to predict the processes for a given operation (e.g., booting). Therefore, when the electronic device 2000 indiscriminately preloads data for quick use of the data, unnecessary data may be loaded into main memory, which may actually degrade the performance of the electronic device 2000.

In an embodiment of the disclosure, the electronic device 2000 may improve the performance of the electronic device 2000 by predicting, for an unpredictable user pattern or environment, a memory address to be used in a next process to be executed by utilizing a predictive model, and preloading data at the predicted address.

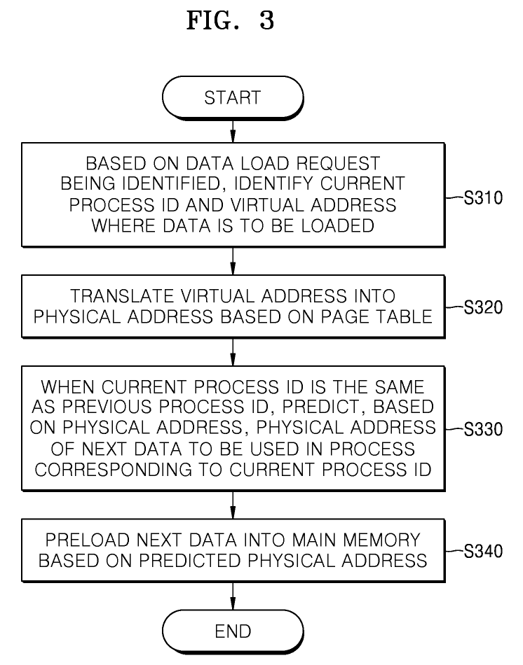

FIG. 3 is a flowchart illustrating an operation in which an electronic device preloads data, according to an embodiment of the disclosure.

In operation S310, based on a data load request being identified, the electronic device 2000 may identify a current process identifier (ID) and a virtual address where data is to be loaded.

In an embodiment of the disclosure, an operating system (or OS) of the electronic device 2000 may create a process. The creation of the process may occur when a program is executed on the electronic device 2000, or in response to a task command for the electronic device 2000 while the electronic device 2000 is operating. For example, one or more processes may be created within an overall process where the electronic device 2000 operates, such as when the user executes a program (e.g., an application), when the operating system of the electronic device 2000 performs a necessary task on its own, or when a parent process creates a child process for a specific task.

The operating system of the electronic device 2000 may allocate or assign a process ID (PID) and a virtual memory space to a process. When a program starts being executed, the process may be allocated a CPU, and when the CPU executes instructions, access various virtual addresses in a virtual memory space to sequentially load data into a main memory, so that tasks within the process may be performed.

Among the above-described operations, when the data load request is identified, the electronic device 2000 may identify the current PID and the virtual address where the data is to be loaded.

In operation S320, the electronic device 2000 may translate the virtual address to a physical address based on a page table.

Because the process use virtual memory to handle virtual addresses, the electronic device 2000 needs to translate virtual addresses into physical addresses in order to access actual memory and use data. In an embodiment of the disclosure, the electronic device 2000 may identify physical addresses mapped to virtual addresses. The mapping information may be included in a page table stored in a storage (permanent memory) of the electronic device 2000.

In operation S330, when the current PID is the same as a previous PID, the electronic device 2000 may predict, based on the physical address, a physical address of next data to be used in a process corresponding to the current PID.

In an embodiment of the disclosure, the electronic device 2000 may identify whether the current PID identified in operation S310 is the same as the previous PID. When the current PID is the same as the previous PID, the electronic device 2000 may predict a physical address of next data by using a predictive model. The predictive model may be a model that takes a physical address as input and outputs a next physical address, and may be configured as a multi-layer perceptron (MLP).

In operation S340, the electronic device 2000 may preload the next data into a main memory based on the predicted physical address.

In an embodiment of the disclosure, the electronic device 2000 may preload, based on the predicted physical address, data stored in the storage of the electronic device 2000 into the main memory. By preloading the data into the main memory, the electronic device 2000 may reduce the time it takes for the CPU to process operations within the process.

In an embodiment of the disclosure, the electronic device 2000 may repeat physical address prediction for subsequent data sequences. For example, each time a data load request is identified in a process, the electronic device 2000 may identify a current PID and a virtual address, and predict a physical address of data to be used next. The electronic device 2000 may execute one or more processes by preloading data at the predicted physical address into the main memory. In other words, the electronic device 2000 may reduce the processing speed of the one or more processes through data preloading.

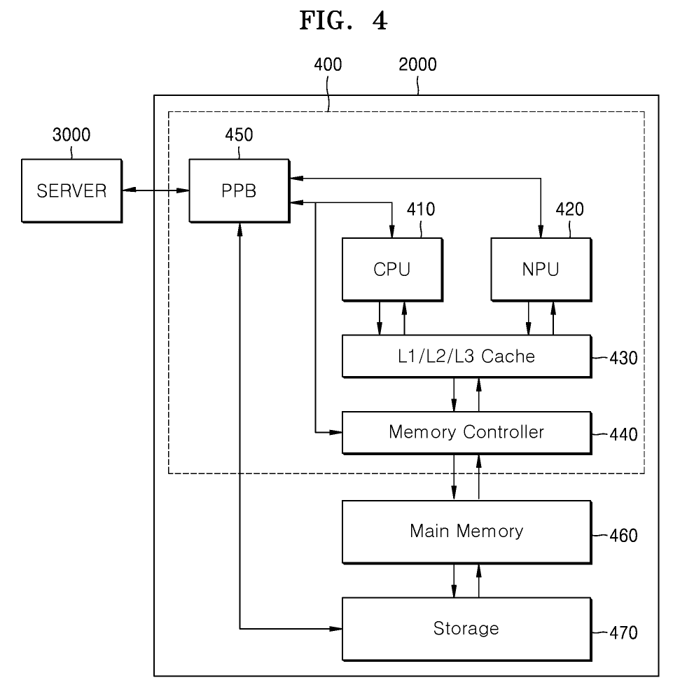

FIG. 4 is a block diagram of a configuration of an electronic device according to an embodiment of the disclosure.

In an embodiment of the disclosure, the electronic device 2000 may include a system on chip (SoC) 400, a main memory 460, and a storage 470.

The SoC 400 may handle various tasks, including computations (or operations) within a process, memory management, and data transfer with the storage 470. The SoC 400 may include, for example, a CPU 410, a neural processing unit (NPU) 420, L1/L2/L3 caches 430, a memory controller 440, and a prediction preload block (PPB) 450, but is not limited thereto.

The CPU 410 may handle computations within a process. When the process is created, the CPU 410 may retrieve instructions from the main memory 460 where program code is loaded, and execute the instructions.

The NPU 420 may be a processor designed to handle tasks related to artificial neural networks. The NPU 420 may handle computations for predicting a physical address for preloading next data in the process.

The L1/L2/L3 caches 430 may store data frequently used by the CPU 410 and/or the NPU 420. The L1/L2/L3 caches 430 may load and store data from the main memory 460, and each cache may have different sizes and speeds depending on its hierarchical level.

The memory controller 440 may manage a data flow between the CPU 410 or NPU 420 and the main memory 460. The memory controller 440 may control access to addresses within memory. When the CPU 410 or NPU 420 attempts to access the memory to read or write data, the memory controller 440 may receive a data load request from the CPU 410 or NPU 420. The data load request may include a virtual address. The memory controller 440 may load data into the main memory 460 according to the data load request. In an embodiment of the disclosure, the memory controller 440 may preload data stored in the storage 470 into the main memory 460 based on a predicted physical address.

The PPB 450 may predict a physical address for data preloading. The PPB 450 may obtain, from the CPU 410, a PID and a virtual address of data to be loaded. The PPB 450 may obtain a page table for address translation from the storage 470. The PPB 450 may manage overall tasks related to a predictive model used to predict a physical address of next data. For example, the PPB 450 may select training data for training the predictive model. The PPB 450 may transmit the training data for the predictive model to a server 3000. The PPB 450 may receive parameters of the trained predictive model from the server 3000 and perform inference using the predictive model. In this case, the inference operation of the predictive model may be performed through the NPU 420.

In an embodiment of the disclosure, the PPB 450 may be a hardware module included in the SoC 400. Alternatively, the PPB 450 may be configured as a combination of a hardware module and a software module. A detailed description of the operation of the PPB 450 is provided below with reference to the subsequent drawings.

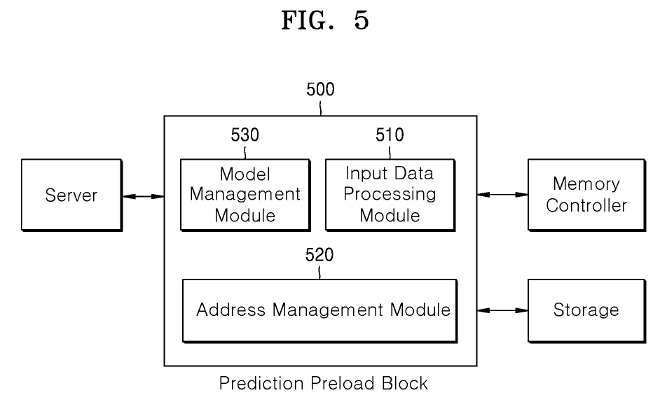

FIG. 5 is a block diagram of a configuration of a PPB in an electronic device, according to an embodiment of the disclosure.

Referring to FIG. 5, a PPB 500 may include an input data processing module 510, an address management module 520, and a model management module 530. The modules of the PPB 500 are briefly described with reference to FIG. 5, and a detailed description related to the operation of the PPB 500 is described with reference to the subsequent drawings.

The PPB 500 performs operations related to predicting a physical address of data for preloading. The PPB 500 may process data to extract data to be input to a predictive model, and transmit, to a memory controller, a predicted physical address output from the predictive model so that data at the corresponding physical address may be preloaded. Each of the modules of the PPB 500 as described below may include hardware components for performing the described functions. For example, each module may include an arithmetic logic unit (ALU), a comparator, and a three-state buffer, but is not limited thereto.

The input data processing module 510 may process data input to the PPB 500. The input data may be a PID identified by a CPU and a virtual address of data to be loaded. The input data processing module 510 may process the input data and transmit the processed data to the address management module 520 or the model management module 530.

The address management module 520 may translate the virtual address into a physical address. The address management module 520 may translate a virtual page number (VPN) into a physical page number (PPN) based on a page table. The PPN obtained via the translation may be transmitted to the model management module 530. The page table may be obtained from a storage.

The model management module 530 may generally process and manage data related to the predictive model. The model management module 530 may select data for training the predictive model, which is received from the input data processing module 510, and generate a training dataset. The model management module 530 may transmit the training dataset to a server so that training of the predictive model may be performed. The transmission of the training dataset may be performed periodically or aperiodically. The model management module 530 may receive parameters of the trained predictive model from the server and operate the predictive model. A physical address output from the predictive model may be transmitted to the memory controller.

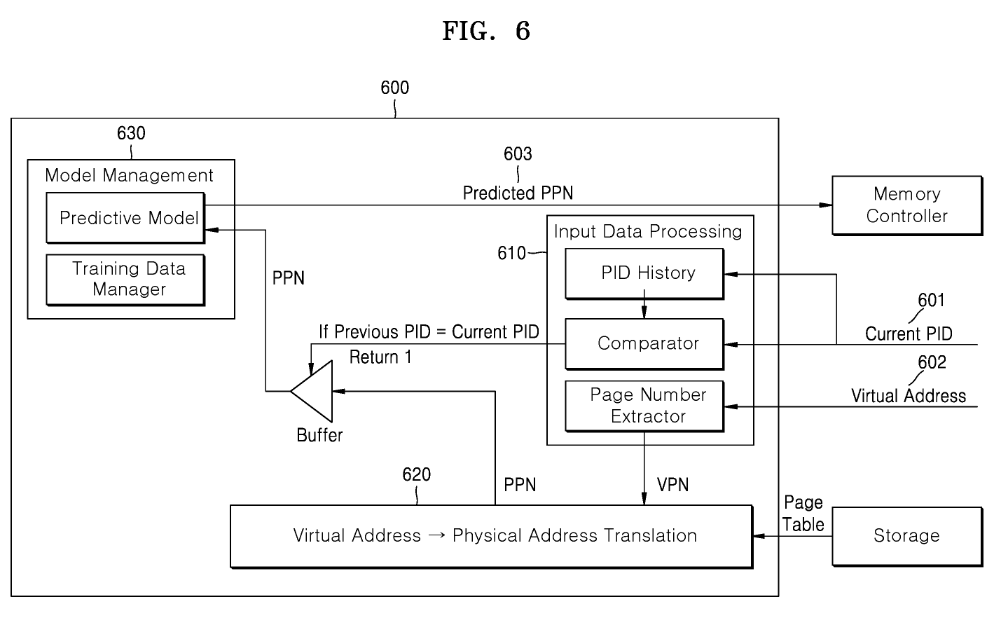

FIG. 6 is a diagram illustrating an operation in which an electronic device predicts a physical address and preloads data, according to an embodiment of the disclosure.

The electronic device 2000 may use a PPB 600 to predict an address of data and preload data at the predicted address. In this case, predicting the address of data refers to an inference process of predicting a PPN by using a predictive model.

In an embodiment of the disclosure, the PPB 600 may take a current PID 601 and a virtual address 602 as input, and output a predicted PPN 603.

When there is a data load request from a process, a CPU accesses a memory address according to program code. In this case, the data load request may include the current PID 601 and the virtual address 602 indicating a location of the data. The PPB 600 may receive the current PID 601 and the virtual address 602 from the CPU.

An input data processing module 610 may create and manage a PID history that is the storage of PIDs for each piece of data. When the current PID 601 is received, the input data processing module 610 may compare a previous PID with the current PID 601 by using a comparator. When the current PID 601 is the same as the previous PID, 1 is returned; otherwise, 0 may be returned. This is to predict a physical address of next data to be loaded in the process when the current process is not switched and is continuously running.

A virtual address may consist of bits representing a VPN and bits representing a page offset. The page number is composed of upper bits of the virtual address and represents a virtual page. The page offset is composed of the remaining lower bits and specifies a specific location within a page. The input data processing module 610 may extract a VPN from the virtual address by using a page number extractor. The input data processing module 610 may transmit the extracted VPN to an address management module 620.

The address management module 620 may translate the VPN into a PPN. The address management module 620 may translate the VPN into the PPN based on a page table. The page table may include mapping information between VPNs and PPNs. In an embodiment of the disclosure, the page table may be stored in storage. The storage may store the entire page table, and a part of the page table containing information about a page currently being accessed may be loaded into a main memory. The PPN obtained via the translation may be transmitted to the model management module 630 and used to predict a next PPN.

In an embodiment of the disclosure, the PPB 600 may select PPNs to be transmitted to the model management module 630. For example, an output may be enabled or disabled by a buffer. The buffer may control the output so that a PPN inference task is performed only when the current PID 601 is the same as the previous PID. The buffer may allow an input PPN to be passed to the output when the current PID 601 is the same as the previous PID, and prevent the input PPN from being output when the current PID 601 is different from the previous PID.

The model management module 630 manages the training or inference of the predictive model. In an inference process using the predictive model, the model management module 630 may input the PPN to the predictive model and obtain the predicted PPN 603 of data to be loaded next. The predictive model may be ready to perform an inference task after training is completed and then model performance is validated. In an embodiment of the disclosure, parameters of the trained predictive model may be received from a server. An inference operation using the predictive model may be performed using an NPU included in an SoC, but is not limited thereto.

In an embodiment of the disclosure, the PPB 600 may transmit the predicted PPN 603 to a memory controller in order to preload the predicted PPN 603.

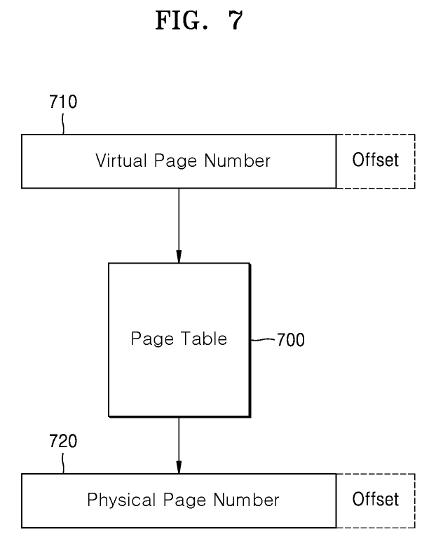

FIG. 7 is a diagram illustrating an operation in which an electronic device translates a virtual address into a physical address, according to an embodiment of the disclosure.

In an embodiment of the disclosure, the electronic device 2000 may perform mapping between virtual addresses and physical addresses by using a page table 700. The page table 700 may be implemented as one of various methods available for address mapping. For example, the address mapping method may be an on-demand page table method where the entire page table is stored in storage, and a required page table or necessary parts of the page table may be loaded into main memory, but is not limited thereto.

The electronic device 2000 may translate virtual addresses into physical addresses by using the page table 700.

The page table 700 may be composed of entries that are fundamental units used to store mapping information between virtual pages and physical pages. Each entry may contain information about a physical page corresponding to a virtual page. An entry may include, for example, a PPN 720, a valid bit indicating the validity of a corresponding page, etc., but is not limited thereto.

A virtual address consists of a VPN 710 and an offset, and a physical address may consist of the PPN 720 and an offset. The electronic device 2000 may separate the virtual address into the VPN 710 and an offset. For example, when the virtual address is in a 64-bit format, the upper 52 bits may be page number bits, and the remaining 12 bits may be page offset bits. The electronic device 2000 may access an index of the page table 700 by using the VPN 710 and identify the PPN 720 in the entry at the corresponding index. Because the offset in the virtual address is identical to the offset in the physical address, the electronic device 2000 may translate the VPN 710 extracted from the virtual address into the PPN 720 and obtain the physical address by combining the offset with the PPN 720.

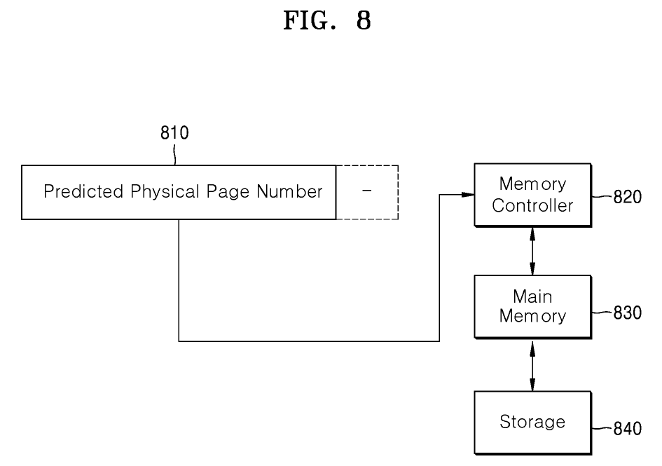

FIG. 8 is a diagram illustrating an operation in which an electronic device preloads data, according to an embodiment of the disclosure.

In an embodiment of the disclosure, the electronic device 2000 may preload data by using a predicted PPN 810 obtained using a predictive model. The preloaded data may refer to data that is predicted to be used next in a process.

The predicted PPN 810 output from a PPB may be transmitted to a memory controller 820. In an embodiment of the disclosure, the predicted PPN 810 may be converted into a form of a physical address. For example, when the physical address is in a 64-bit format, the predicted PPN 810 is 52 bits, and an offset is 12 bits, a shift operation may be performed on the predicted PPN 810 to convert the predicted PPN 810 into the 64-bit physical address. In this case, a value of the offset may not be set. This may mean loading the entire page corresponding to the predicted PPN 810.

The memory controller 820 may check whether data exists at the physical address obtained from the predicted PPN 810 in a main memory 830. When the corresponding physical address value is accessible in the main memory 830, it may be determined that the data to be preloaded is already in the main memory 830. When the physical address value is not accessible in the main memory 830, it may be determined that the data to be preloaded is not present in the main memory 830. In this case, the memory controller 820 may load the data corresponding to the physical address from a storage 840 into the main memory 830 so that the data is preloaded. The preloaded data may be used when a command to load the data is issued by the process at a later time.

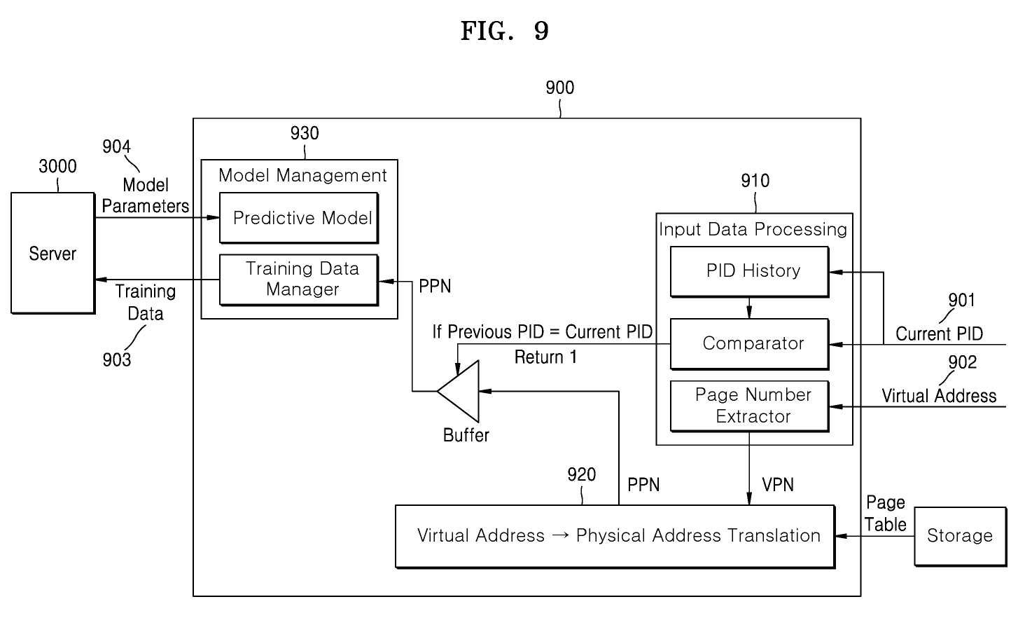

FIG. 9 is a diagram illustrating an operation in which an electronic device trains a predictive model for predicting a physical address, according to an embodiment of the disclosure.

The electronic device 2000 may select training data for training a predictive model by using a PPB 900. The electronic device 2000 may collect and select data from processes during operation of the electronic device 2000 to thereby generate a training dataset representing a physical address pattern.

In an embodiment of the disclosure, the PPB 900 may take a current PID 901 and a virtual address 902 as input and generate training data 903 through a data processing procedure and a selection process. The training data 903 may be transmitted to the server 3000. The server 3000 may train the predictive model by using the training data 903. The server 3000 may be a device that includes high-performance hardware (e.g., graphics processing unit (GPU), a tensor processing unit (TPU), etc.) capable of quickly processing large amounts of data and complex calculations for artificial intelligence (AI) training. The server 3000 may train the predictive model and provide model parameters 904 of the trained predictive model to the electronic device 2000.

The PPB 900 may select and collect PPNs for processes performed in the electronic device 2000. When there is a data load request from a process, the PPB 900 may identify the current process ID 901 and the virtual address 902.

The input data processing module 910 may identify whether the current PID 901 is the same as a previous PID, extract a VPN from the virtual address 902, and transmit the VPN to an address management module 920. The address management module 920 may translate the VPN into a PPN based on a page table.

The PPN obtained via the translation may be output or not output by a buffer. The buffer may control the output so that a PPN is learned only when the current PID 901 is the same as the previous PID. When the current PID 901 is the same as the previous PID, the PPN may be passed to a model management module 930, and a training data manager of the model management module 930 may store the passed data as a PPN pattern. By using the PPN pattern, the training data manager may generate the training data 903 that associates the current PPN with a next PPN.

In an embodiment of the disclosure, to predict physical addresses of data to be loaded sequentially within the process, the PPB 900 may pattern addresses of data loaded within the same process. Because processes are executed in an interleaved manner according to scheduling, when data is patterned based only on whether a process ID is the same as a previous process ID, all physical addresses included in a single process are not stored as a pattern. For example, because another process may be executed before one process is completely executed, storing physical addresses based on the sameness of a PID may result in storing only physical addresses for some of the data within a process, rather than all of the data.

However, the number of processes is quite large, and organizing and storing of physical addresses related to data loads for all processes process-by-process is inefficient because this requires significant memory and computational resources. Therefore, the PPB 900 may increase the efficiency of generating data patterns for predicting physical addresses by selectively patterning physical addresses for only some of the data sequences included in a single process. In this case, a PID is used only to identify the same process, and may not be included in the training data 903. This is because the PPB 900 generates the training data 903 based only on which physical addresses are accessed sequentially within the same process, rather than by tracking many processes individually.

In an embodiment of the disclosure, the server 3000 may receive the training data 903 from the electronic device 2000 and train the predictive model. The electronic device 2000 may receive, from the server 3000, the predictive model updated based on a preset period. For example, the predictive model may be updated daily and received by the electronic device 2000, but is not limited thereto.

In an embodiment of the disclosure, the electronic device 2000 may directly train the predictive model by using the training data 903. The trained predictive model may be used to perform an inference task for predicting physical addresses. Because the inference task of the predictive model has already been described in the description of FIG. 6, a repeated description thereof is omitted for brevity.

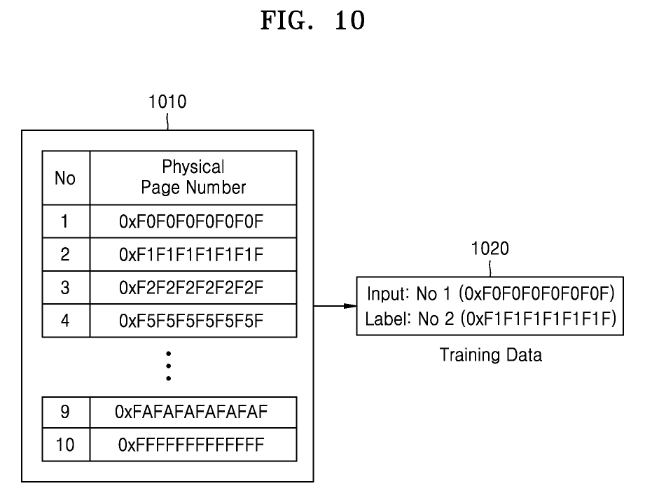

FIG. 10 is a diagram illustrating an operation in which an electronic device generates training data for a predictive model, according to an embodiment of the disclosure.

In an embodiment of the disclosure, the electronic device 2000 may generate training data 1020 for a predictive model based on a physical address pattern 1010. The physical address pattern 1010 may represent a pattern of PPNs, but is not limited thereto.

The physical address pattern 1010 may be a set of physical addresses of data identified as being loaded within the same process. For example, a PPN of data loaded first in a single process may be 52-bit 0xF0F0F0F0F0F0F, and a PPN of data loaded next may be 52-bit 0xF1F1F1F1F1F1F.

The electronic device 2000 may generate training data 1020 including input-label pairs, each consisting of the PPN of the current data–the PPN of the next data. In the example of FIG. 10, the training data 1020 indicates that the label 0xF0F0F0F0F0F0F is assigned to the input 0xF1F1F1F1F1F1F.

In the same manner as the example described above, for sequential physical addresses within the physical address pattern 1010, the electronic device 2000 may generate the training data 1020 including input-label pairs, each consisting of a physical address of the current data and a physical address of the next data. In other words, the training data 1020 may consist of a large amount of data labeled with physical addresses of adjacent data. The training data 1020 may be used for training the predictive model.

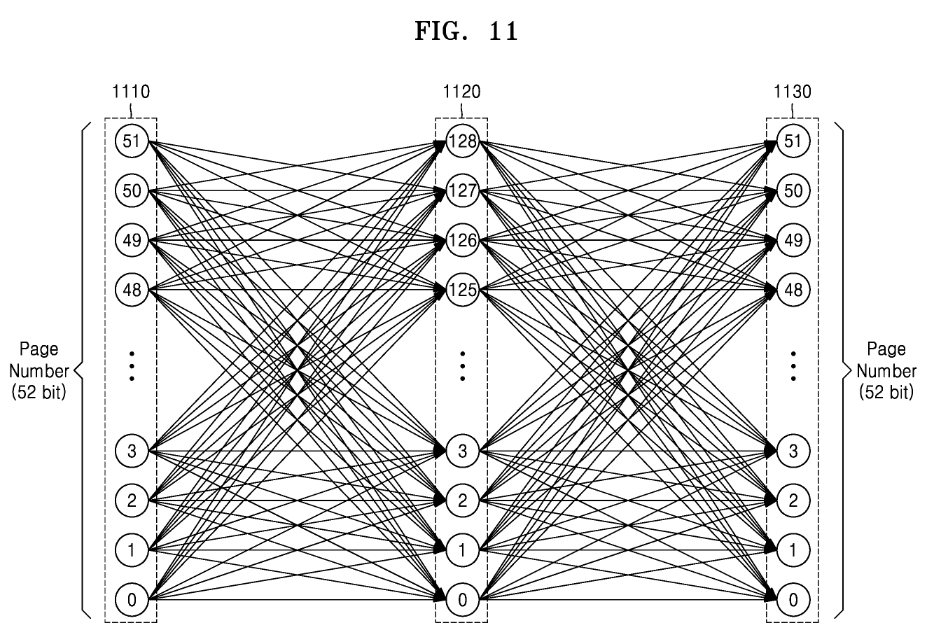

FIG. 11 is a diagram illustrating a predictive model used by an electronic device to predict a physical address, according to an embodiment of the disclosure.

In an embodiment of the disclosure, the predictive model may be configured to include an MLP. The predictive model is capable of learning a non-linear relationship between input data and output data. The predictive model may include an input layer 1110, a hidden layer 1120, and an output layer 1130.

The input layer 1110 is a layer that takes a PPN as input. For example, when the predictive model takes a 52-bit PPN as input, the number of nodes in the input layer 1110 may be 52. Each node in the input layer 1110 may receive one bit of the input and transmit data to the hidden layer 1120.

The hidden layer 1120 may extract features of the data from the input data. There may be one or more hidden layers 1120. For example, the hidden layer 1120 may be configured as a single layer to reduce complexity and computational cost, but is not limited thereto. The hidden layer 1120 may include nodes for learning various combinations of the input data. Each node in the hidden layer 1120 may have a set of weights and a bias to combine the input layer with different weights. For example, when there are 128 nodes in the hidden layer 1120, each of the 128 nodes may have its own set of weights and a bias. The hidden layer 1120 may transmit, to the output layer 1130, an output value to which an activation function has been applied. The activation function may include, for example, rectified linear unit (ReLU), sigmoid, etc., but is not limited thereto.

The output layer 1130 is a layer that outputs a PPN. After the predictive model is trained, when input data (a PPN) is input to the trained predictive model, output data (a predicted PPN) may be output through the output layer 1130. For example, when the predicted PPN that is the output data is 52 bits, the number of nodes in the output layer 1130 may be 52. Each node in the output layer 1130 outputs 1 bit, and a 52-bit output may be predicted through outputs of all nodes.

In an embodiment of the disclosure, the electronic device 2000 may train the predictive model. The predictive model may be trained based on training data, and a training process may include iterations of forward propagation for applying weights and biases, loss calculation for calculating an error between output data and ground truth, backpropagation for calculating the effect of the error on weights of each layer, and updating the weights and biases.

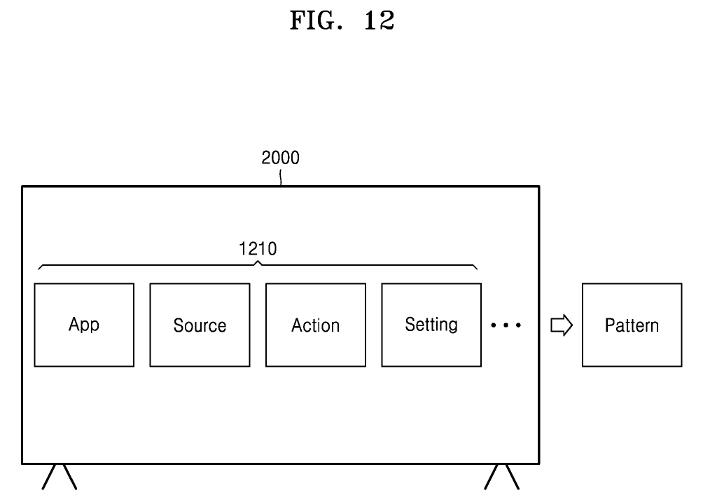

FIG. 12 is a diagram illustrating an operation in which an electronic device collects a usage pattern of the electronic device, according to an embodiment of the disclosure.

In an embodiment of the disclosure, the electronic device 2000 may collect a usage history 1210 of the electronic device 2000. The usage history 1210 of the electronic device 2000 may include, but is not limited to, histories related to applications, sources, actions, settings, etc.

An application history may include records of memory access patterns that occur during the execution of an application on the electronic device 2000 and the user's interaction with the application. For example, the application history may include, but is not limited to, an application name, a usage time, a network status (e.g., network type, network speed, connection strength, etc.), operations performed within the application, etc.

A source history may include records of memory access patterns that occur during the use of a source connected to the electronic device 2000. For example, the source history may include, but is not limited to, connected source type (e.g., High-Definition Multimedia Interface (HDMI), game console, set-top box, etc.), resolution, streaming information, connection time, functions used, network status, etc.

An action history may include records of memory access patterns that occur during the user's interaction with the electronic device 2000 through user actions on the electronic device 2000. For example, the action history may include, but is not limited to, an action type (e.g., navigation, channel change, volume control, etc.), a target (e.g., menu, channel, volume, etc.), a device states (e.g., screen mode, sound mode, etc.), the number of actions, time of action occurrence, etc.

A setting history may include records of memory access patterns that occur when settings are applied or changed in the electronic device 2000. For example, the setting history may include, but is not limited to, setting items, setting values before and after changes, and the time when settings were applied.

The electronic device 2000 may generate a usage pattern based on the usage history 1210. The usage pattern may include, for example, a usage history for applications, a usage history for sources, an action history, and a setting history, but is not limited thereto.

The electronic device 2000 may generate a physical address pattern based on the usage pattern. For example, electronic device 2000 may generate a physical address pattern by patterning physical addresses when accessing memory for data loading in one or more processes included in each usage pattern.

The electronic device 2000 generates training data for a predictive model based on the physical address pattern and trains the predictive model, thereby allowing the predictive model to predict physical addresses of data to be loaded for an unstructured process in various usage environments of the electronic device 2000 so that the data may be preloaded at the predicted physical addresses.

For example, even for the same electronic device 2000, processes executed at boot time may differ depending on a usage environment of the electronic device 2000 (e.g., network connection, user personal settings, etc.). By using a predictive model that has learned memory access patterns corresponding to usage patterns, the electronic device 2000 may reduce the boot time by loading, in advance, data necessary for booting the electronic device 2000 from a storage into a main memory. For example, the electronic device 2000 may preload Wi-Fi connection information, account information, app-related data, etc. required during bootup into the main memory, thereby reducing the time a CPU spends waiting for the data.

For example, because each user of the electronic device 2000 uses the electronic device 2000 according to his or her own personalized pattern, processes that are executed may be different for each user. By using a predictive model that has learned memory access patterns corresponding to usage patterns, the electronic device 2000 may reduce response time by loading, in advance, data required for use of the electronic device 2000 from the storage into the main memory.

For example, when a usage pattern of the user is that the user generally tends to terminate app A and then launch app B, the electronic device 2000 may preload data related to the execution of app B into the main memory when app A is terminated, thereby reducing the time the CPU spends waiting for the data.

For example, when a usage pattern of the user is that the user tends to watch a live broadcast and then launch a video platform app, the electronic device 2000 may preload data related to the execution of the video platform app into the main memory while the live broadcast is playing on a screen, thereby reducing the time the CPU spends waiting for the data.

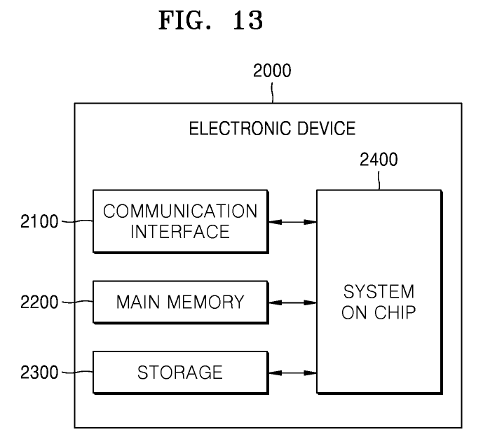

FIG. 13 is a block diagram of a configuration of an electronic device according to an embodiment of the disclosure.

In an embodiment of the disclosure, the electronic device 2000 may include a communication interface 2100, a main memory 2200, a storage 2300, and an SoC 2400.

The communication interface 2100 may perform data communication with another electronic device (e.g., a server) according to control by the SoC 2400.

The communication interface 2100 is capable of performing data communication between the electronic device 2000 and other electronic devices (e.g., a server, an external electronic device, etc.) by using at least one of data communication methods including, for example, wired local area network (LAN) (e.g., Ethernet), wireless LAN (e.g., Wi-Fi), cellular networks (4th generation (4G), 5th generation (5G), etc.), Bluetooth, Bluetooth Low Energy (BLE), ZigBee, Infrared Data Association (IrDA), near field communication (NFC), radio frequency (RF) communication, and various other types of known wireless/wired communication technologies. The communication interface 2100 may include communication circuitry designed to utilize the above-described communication methods.

The main memory 2200 may store data currently being processed by the electronic device 2000. The main memory 2200 may store programs being executed by a CPU or NPU of the SoC 2400 and enable quick access thereto. The main memory 2200 may include volatile memory such as RAM or static RAM (SRAM), but is not limited thereto.

The storage 2300 may permanently store large amounts of data (e.g., programs, system files, etc.). The storage 2300 may include non-volatile memory including, for example, at least one of a hard disk drive (HDD), a solid state drive (SSD), an optical drive (e.g., a compact disc (CD)), a flash drive, read-only memory (ROM), electrically erasable programmable ROM (EEPROM), or PROM, but is not limited thereto.

The SoC 2400 may control all operations of the electronic device 2000. The SoC 2400 may include processing circuitry. For example, a processor, which is processing circuitry included in the SoC 2400, may consist of, but is not limited to, at least one of a CPU, a microprocessor, a GPU, application-specific integrated circuits (ASICs), digital signal processors (DSPs), digital signal processing devices (DSPDs), programmable logic devices (PLDs), field programmable gate arrays (FPGAs), or an application processor (AP).

The processor may be configured as one or more processors. When the processor is configured as one or more processors, operations according to the disclosure may be performed by the one or more processors individually or collectively executing instructions and/or programs stored in a memory. When a method according to an embodiment of the disclosure includes a plurality of operations, the plurality of operations may be performed by one processor or a plurality of processors.

For example, when a first operation, a second operation, and a third operation are performed according to a method of an embodiment of the disclosure, the first operation, the second operation, and the third operation may all be performed by a first processor, or some of the first to third operations may be performed by the first processor (e.g., a general-purpose processor) while the remaining operations may be performed by a second processor (e.g., a dedicated AI processor). Here, computations for training/inference of AI models may be performed by the dedicated AI processor, which is an example of the second processor. However, an embodiment of the disclosure is not limited thereto. For example, an inference process using a predictive model may be processed by an NPU, and the process of handling a process may be handled by a CPU.

The one or more processors according to the disclosure may be implemented as a single-core processor or as a multi-core processor. When a method according to an embodiment of the disclosure includes a plurality of operations, the plurality of operations may be performed by a single core, or may be performed by a plurality of cores included in the one or more processors.

When a program is loaded from the storage 2300 to the main memory 2200 in response to a program load request that is a request to execute one or more instructions of the program, the processor of the SoC 2400 may process the program by executing the instructions and performing computations.

The SoC 2400 may include, in addition to the processor, a cache memory, a memory controller, and a PPB. The cache memory may store data used by the CPU and/or the NPU, and the memory controller may manage a data flow between the CPU and/or NPU and the main memory 2200. The PPB may predict physical addresses for data preloading. Because each of the components has been described with reference to the previous drawings, repeated descriptions thereof are omitted.

In an embodiment of the disclosure, the electronic device 2000 may include various types of devices including a display. For example, the electronic device 2000 may include a TV, a smart monitor, a tablet personal computer (PC), a laptop PC, a digital signage, a large display, a 360-degree projector, a smartphone, etc. In an embodiment of the disclosure, the electronic device 2000 may be implemented without a display. The electronic device 2000 may include, but is not limited to, a set-top box, a desktop PC, etc., which are connectable to a separate external display.

In an embodiment of the disclosure, the operations of the server 3000 described above may be replaced with operations performed by the electronic device 2000. For example, to perform functions that are identical or similar to those of the server 3000, the electronic device 2000 may include programs and instructions, hardware modules, and software modules for training a predictive model.

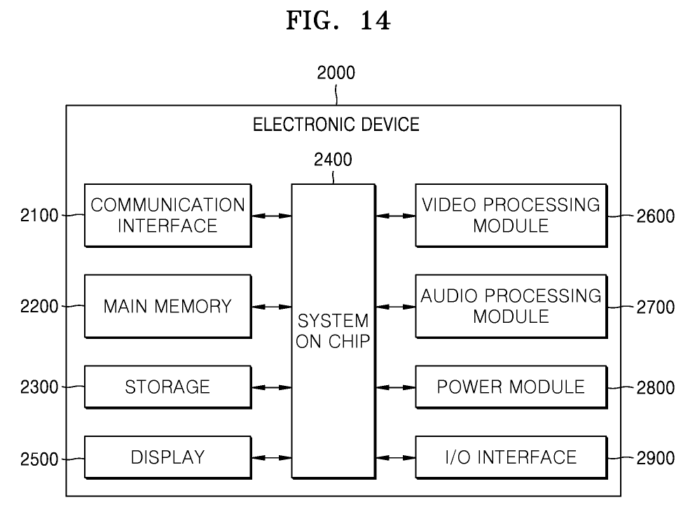

FIG. 14 is a block diagram of a configuration of an electronic device according to an embodiment of the disclosure.

In an embodiment of the disclosure, the electronic device 2000 may include a communication interface 2100, a main memory 2200, a storage 2300, an SoC 2400, a display 2500, a video processing module 2600, an audio processing module 2700, a power module 2800, and an input/output (I/O) interface 2900.

The communication interface 2100, the main memory 2200, the storage 2300, and the SoC 2400 respectively correspond to the communication interface 2100, the main memory 2200, the storage 2300, and the SoC 2400 illustrated in FIG. 13, so repeated descriptions thereof are omitted.

The display 2500 may output an image signal onto the screen of the electronic device 2000 according to control by a processor included in the SoC 2400.

A sensor (not shown) may obtain sensor data. The sensor may be one or more sensors. The processor of the electronic device 2000 may process the sensor data to obtain information. The sensor may include, but is not limited to, an infrared (IR) receiver for detecting a remote control signal.

The video processing module 2600 performs processing on video data played by the electronic device 2000. The video processing module 2600 may perform various types of image/video processing, such as decoding, scaling, noise reduction, frame rate conversion, resolution conversion, rendering, etc., on the video data. The display 2500 may generate a driving signal by converting an image signal, a data signal, an on-screen display (OSD) signal, a control signal, etc. processed by the processor, and display an image according to the driving signal.

The audio processing module 2700 performs processing on audio data played by the electronic device 2000. The audio processing module 2700 may perform various types of processing, such as decoding, amplification, noise reduction, etc., on the audio data.

The power module 2800 supplies, according to control by the processor of the electronic device 2000, power input from an external power source to internal components of the electronic device 2000. The power module 2800 may also supply, according to control by the processor of the electronic device 2000, power output from one or more batteries located within the electronic device 2000 to the internal components.

The I/O interface 2900 processes an input/an output from outside of the electronic device 2000. The I/O interface 2900 receives video (e.g., a moving image, etc.), audio (e.g., voice, music, etc.), additional information (e.g., an electronic program guide (EPG), etc.), and the like. The I/O interface 2900 may include one of a Universal Serial Bus (USB), an HDMI, a Mobile High-Definition Link (MHL), a DisplayPort (DP), a Thunderbolt, a Video Graphics Array (VGA) port, a red, green, and blue (RGB) port, a D-subminiature (D-sub), a Digital Visual Interface (DVI), a component jack, a PC port, and an audio jack. That is, the I/O interface 2900 may be implemented to include a plurality of modules (e.g., a USB port, an HDMI port, etc.) for implementing the above-described input/output methods. The electronic device 2000 may be connected to external devices, such as a display, a camera, a microphone, a speaker, a touch pad, etc., via the I/O interface 2900.

The disclosure provides a method and an electronic device for performing the method, for improving process handling performance by predicting an address of data to be loaded and preloading data at the predicted address based on analysis and patternization of unstructured processes. The technical solutions to be achieved in the disclosure are not limited to those described above, and other technical solutions not described will be clearly understood by one of ordinary skill in the art from the description herein.

According to an aspect of the disclosure, an electronic device for performing a data preloading method may be provided.

The electronic device may include an SoC including at least one processor, and a storage storing instructions and a main memory into which the instructions are loaded.

The instructions, when executed by the at least one processor in the SoC, may cause the electronic device to identify, based on a data load request being identified, a current PID and a virtual address where data is to be loaded.

The instructions, when executed by the at least one processor in the SoC, may cause the electronic device to translate the virtual address into a physical address based on a page table stored in the storage.

The instructions, when executed by the at least one processor in the SoC, may cause the electronic device to, when the current PID is the same as a previous PID, predict, based on the physical address, a physical address of next data to be used in a process corresponding to the current PID.

The instructions, when executed by the at least one processor in the SoC, may cause the electronic device to preload the next data into the main memory based on the predicted physical address.

The instructions, when executed by the at least one processor in the SoC, may cause the electronic device to translate, based on the page table, a VPN extracted from the virtual address into a PPN.

The instructions, when executed by the at least one processor in the SoC, may cause the electronic device to predict a PPN of the next data by inputting the PPN to a predictive model.

The instructions, when executed by the at least one processor in the SoC, may cause the electronic device to obtain the predicted physical address by converting the predicted PPN into a physical address.

The instructions, when executed by the at least one processor in the SoC, may cause the electronic device to identify whether the next data is in the main memory.

The instructions, when executed by the at least one processor in the SoC, may cause the electronic device to, when the next data is not in the main memory, preload the next data from the storage into the main memory based on the predicted physical address.

The predictive model may be configured as an MLP.

The predictive model may be trained based on training data including input-label pairs consisting of a PPN of current data–a PPN of next data.

The instructions, when executed by the at least one processor in the SoC, may cause the electronic device to, for processes that are executed in an interleaved manner according to scheduling, identify physical addresses of data loaded within the same process based on a PID.

The instructions, when executed by the at least one processor in the SoC, may cause the electronic device to generate the training data based on a physical address pattern of the physical addresses in the same process.

The instructions, when executed by the at least one processor in the SoC, may cause the electronic device to collect a user's usage history of the electronic device.

The instructions, when executed by the at least one processor in the SoC, may cause the electronic device to generate a usage pattern for one or more applications based on the usage history.

The instructions, when executed by the at least one processor in the SoC, may cause the electronic device to generate the physical address pattern for each process based on the usage pattern.

The electronic device may include a communication interface.

The instructions, when executed by the at least one processor in the SoC, may cause the electronic device to transmit the training data to a server via the communication interface.

The instructions, when executed by the at least one processor in the SoC, may cause the electronic device to receive, from the server, via the communication interface, parameters of the predictive model trained using the training data.

The predictive model may be periodically updated based on a defined period and received from the server.

The instructions, when executed by the at least one processor in the SoC, may cause the electronic device to execute one or more processes by repeating physical address prediction for subsequent data sequences.

The SoC may include an NPU.

The instructions, when executed by the at least one processor in the SoC, may cause the electronic device to predict, by using the NPU, the PPN of the next data by using the predictive model.

According to an aspect of the disclosure, a method, performed by an electronic device, of preloading data may be provided.

The method may include, based on a data load request being identified, identifying a current PID and a virtual address where data is to be loaded.

The method may include translating the virtual address into a physical address based on a page table.

The method may include, when the current PID is the same as a previous PID, predicting, based on the physical address, a physical address of next data to be used in a process corresponding to the current PID.

The method may include preloading the next data into a main memory based on the predicted physical address.

The translating of the virtual address into the physical address may include translating a VPN extracted from the virtual address into a PPN.

The predicting of the physical address of the next data may include predicting a PPN of the next data by inputting the PPN to a predictive model.

The predicting of the physical address of the next data may include obtain the predicted physical address by converting the predicted PPN into a physical address.

The preloading of the next data may include identifying whether the next data is in the main memory, and when the next data is not in the main memory, preloading the next data from a storage into the main memory based on the predicted physical address.

The predictive model may be configured as an MLP.

The predictive model may be trained based on training data including input-label pairs consisting of a PPN of current data–a PPN of next data.

The method may include, for processes that are executed in an interleaved manner according to scheduling, identifying physical addresses of data loaded within the same process based on a PID.

The method may include generating the training data based on a physical address pattern of the physical addresses in the same process.

The method may include collecting a user's usage history of the electronic device.

The method may include generating a usage pattern for one or more applications based on the usage history.

The generating of the training data may include generating the physical address pattern for each process based on the usage pattern.

The method may include transmitting the training data to a server.

The method may include receiving, from the server, parameters of the predictive model trained using the training data.

The receiving of the parameters of the predictive model from the server may include receiving, from the server, the predictive model that is periodically updated based on a defined period.

The method may include executing one or more processes by repeating physical address prediction for subsequent data sequences.

The predicting of the PPN of the next data may include predicting, by using an NPU, the PPN of the next data by using the predictive model.

Moreover, embodiments of the disclosure may be implemented in the form of recording media including instructions executable by a computer, such as a program module executed by the computer. The computer-readable recording media may be any available media that are accessible by a computer, and include both volatile and nonvolatile media and both removable and non-removable media. Furthermore, the computer-readable recording media may include computer storage media and communication media. The computer storage media include both volatile and nonvolatile and both removable and non-removable media implemented using any method or technology for storage of information such as computer-readable instructions, data structures, program modules, or other data. The communication media may typically embody computer-readable instructions, data structures, program modules, or other data in a modulated data signal.

A computer-readable storage medium may be provided in the form of a non-transitory storage medium. In this regard, the term 'non-transitory storage medium' only means that the storage medium does not include a signal (e.g., an electromagnetic wave) and is a tangible device, and the term does not differentiate between where data is semi-permanently stored in the storage medium and where the data is temporarily stored in the storage medium. For example, the 'non-transitory storage medium' may include a buffer for temporarily storing data.

According to an embodiment of the disclosure, methods according to various embodiments of the disclosure may be included in a computer program product when provided. The computer program product may be traded, as a product, between a seller and a buyer. The computer program product may be distributed in the form of a machine-readable storage medium (e.g., CD-ROM) or distributed (e.g., downloaded or uploaded) on-line via an application store or directly between two user devices (e.g., smartphones). For online distribution, at least a part of the computer program product (e.g., a downloadable app) may be at least transiently stored or temporally generated in a machine-readable storage medium such as a memory of a server of a manufacturer, a server of an application store, or a relay server.

The above description of the disclosure is provided for illustration, and it will be understood by those of ordinary skill in the art that changes in form and details may be readily made therein without departing from technical idea or essential features of the disclosure. Accordingly, it should be understood that the above-described embodiments of the disclosure and all aspects thereof are merely examples and are not limiting. For example, each component defined as an integrated component may be implemented in a distributed manner, and likewise, components defined as separate components may be implemented in an integrated form.

The scope of the disclosure is defined not by the detailed description thereof but by the following claims, and all the changes or modifications within the meaning and scope of the appended claims and their equivalents will be construed as being included in the scope of the disclosure.

Claims:

1. An electronic device for performing a data preloading method, the electronic device comprising:
a system on chip including at least one processor; and
a storage to store instructions and a main memory into which the instructions are loaded,
wherein the instructions are executable by the at least one processor in the system on chip to cause the electronic device to:
identify, based on a data load request, a current process identifier (ID) and a virtual address where data is to be loaded,
translate the virtual address into a physical address based on a page table stored in the storage,
when the current process ID is the same as a previous process ID, predict a physical address of next data to be used in a process corresponding to the current process ID based on the translated physical address, and
preload the next data into the main memory based on the predicted physical address.

2. The electronic device of claim 1, wherein
the instructions are executable by the at least one processor in the system on chip to cause the electronic device to:
translate, based on the page table, a virtual page number extracted from the virtual address into a physical page number,
predict a physical page number of the next data by inputting the physical page number to a predictive model, and
obtain the predicted physical address by converting the predicted physical page number into a physical address.

3. The electronic device of claim 2, wherein the instructions are executable by the at least one processor in the system on chip to cause the electronic device to identify whether the next data is in the main memory, and when the next data is not in the main memory, preload the next data from the storage into the main memory based on the predicted physical address.

4. The electronic device of claim 2, wherein the predictive model is configured as a multi-layer perceptron (MLP), and is trained based on training data including input-label pairs consisting of a physical page number of current data–a physical page number of next data.

5. The electronic device of claim 4, wherein
the instructions are executable by the at least one processor in the system on chip to cause the electronic device to,
for processes that are executed in an interleaved manner according to scheduling, identify physical addresses of data loaded within the same process based on a process ID, and
generate the training data based on a physical address pattern of the physical addresses in the same process.

6. The electronic device of claim 5, wherein
the instructions are executable by the at least one processor in the system on chip to cause the electronic device to
collect usage history of a user of the electronic device,
generate a usage pattern for one or more applications based on the usage history, and
generate the physical address pattern for each process based on the usage pattern.

7. The electronic device of claim 5, further comprising
a communication interface,
wherein the instructions are executable by the at least one processor in the system on chip to cause the electronic device to
transmit the training data to a server via the communication interface, and
receive, from the server, via the communication interface, parameters of the predictive model trained using the training data.

8. The electronic device of claim 7, wherein the predictive model is periodically updated based on a defined period and received from the server.

9. The electronic device of claim 2, wherein the instructions are executable by the at least one processor in the system on chip to cause the electronic device to execute one or more processes by repeating physical address prediction for subsequent data sequences.

10. The electronic device of claim 2, wherein
the system on chip comprises a neural processing unit (NPU), and
the instructions are executable by the at least one processor in the system on chip to cause the electronic device to
predict, by using the NPU, the physical page number of the next data by using the predictive model.

11. A method, performed by an electronic device, of preloading data, the method comprising:
identifying, based on a data load request, a current process identifier (ID) and a virtual address where data is to be loaded;
translating the virtual address into a physical address based on a page table;
when the current process ID is the same as a previous process ID, predicting a physical address of next data to be used in a process corresponding to the current process ID based on the translated physical address; and
preloading the next data into a main memory based on the predicted physical address.

12. The method of claim 11, wherein
the translating of the virtual address into the physical address comprises
translating a virtual page number extracted from the virtual address into a physical page number, and
the predicting of the physical address of the next data comprises:
predicting a physical page number of the next data by inputting the physical page number to a predictive model; and
obtaining the predicted physical address by converting the predicted physical page number into a physical address.

13. The method of claim 12, wherein the preloading of the next data comprises identifying whether the next data is in the main memory, and when the next data is not in the main memory, preloading the next data from a storage into the main memory based on the predicted physical address.

14. The method of claim 12, wherein the predictive model is configured as a multi-layer perceptron (MLP), and is trained based on training data including input-label pairs consisting of a physical page number of current data–a physical page number of next data.

15. The method of claim 14, further comprising:
for processes that are executed in an interleaved manner according to scheduling, identifying physical addresses of data loaded within the same process based on a process ID; and
generating the training data based on a physical address pattern of the physical addresses in the same process.

16. The method of claim 15, further comprising:
collecting usage history of a user of the electronic device; and
generating a usage pattern for one or more applications based on the usage history,
wherein the generating of the training data comprises generating the physical address pattern for each process based on the usage pattern.

17. The method of claim 15, further comprising:
transmitting the training data to a server; and
receiving, from the server, parameters of the predictive model trained using the training data.

18. The method of claim 17, wherein the receiving of the parameters of the predictive model from the server comprises receiving, from the server, the predictive model that is periodically updated based on a defined period.

19. The method of claim 12, further comprising executing one or more processes by repeating physical address prediction for subsequent data sequences.

20. The method of claim 12, wherein the predicting of the physical page number of the next data comprises predicting, by using a neural processing unit (NPU), the physical page number of the next data by using the predictive model.
